(19) United States
(12) Patent Application Publication
(10) Pub. No.: US 2005/0090912 A1
(43) Pub. Date: Apr. 28, 2005

(54) Two-dimensional position control method and two-dimensional position control apparatus

(75) Inventors: Atsushi Ichikawa, Ibaraki-ken (JP); Shinji Tsukamoto, Saitama-ken (JP); Tomohiro Fujita, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/973,615

(22) Filed: Oct. 27, 2004

(30) Foreign Application Priority Data
Oct. 28, 2003 (JP) 2003-366912

(51) Int. Cl. G05B 19/18

(52) U.S. Cl. 700/66

(57) ABSTRACT

There is provided a two-dimensional position control method which carries out two-dimensional position control fast at a minimum wobbling frequency. The method includes a step of oscillating at least either a space propagation energy distributed in a substantially limited range on a predetermined two-dimensional plane or energy input system to which the energy is input such that a locus of a relative movement thereof forms an ellipse on the two-dimensional plane, a step of detecting energies at least two pairs of points on the elliptic locus on both sides of the center of the ellipse, and a step of calculating differences between the detected energies at the respective pairs of points, thereby detecting a displacement between the energy and the energy input system on the two-dimensional plane.

### BACKGROUND OF THE INVENTION

The present invention relates to a position control method and a position control apparatus which control mutual positions of an output energy and energy receiving device to which the output energy is input based on a displacement between the positions thereof, and particularly, to a two-dimensional position control thereof.

A wobbling method is one of conventional methods for detecting a displacement between a target and an object to be controlled to change its position. This method carries out the position control in an apparatus which transmits an energy by propagating the energy through a space.

The method includes:
oscillating (wobbling) at least one of (1) a position of an energy medium such as an electromagnetic wave, a sound wave and the like, or (2) a position of a detector which detects the energy transmitted by the energy medium at a frequency higher than a controllable frequency;
detecting an output of the detector at a plurality of timing points within a wobbling cycle;
generating a displacement signal representing a displacement based on differences in the output between the plurality of timing points; and
feeding back the displacement signal to carry out the positioning control.

For wobbling a spatial distributional position of the energy medium such as the electromagnetic wave or the sound wave, a source of the energy medium or the position of the detector disposed in a propagation path of the medium may be wobbled.

Japanese Patent Provisional Publication No. HEI 07-174942 discloses an example of the wobbling methods, which mechanically wobbles an energy medium or a detector. According to the above-mentioned publication, the energy medium is a laser beam emitted by a semiconductor laser element, and a detector is an optical fiber, the laser beam incident on the optical fiber being detected by a photodetector. In this configuration, either the laser beam or the optical fiber is wobbled in two directions orthogonal to an optical axis thereof, and there is thus detected a mutual displacement (between the laser beam and the optical fiber) in terms of these two directions (namely two dimensions).

Also according to the above-mentioned publication, if the relative displacement cannot be detected as the displacement between the laser beam and the target point becomes too large, a rough movement control system which increases the oscillation amplitude of the wobbling of the laser beam or the optical fiber is used to search for a position at which the laser beam is incident on the optical fiber, and the relative position control between the laser beam and the optical fiber is then started when the quantity of the incident beam is equal to or more than a predetermined quantity and the displacement is equal to or less than a predetermined quantity.

According to the above-mentioned publication, the two-dimensional relative position control is carried out for the laser beam and the optical fiber by wobbling the optical fiber alternatingly in two directions. Thus, to obtain accurate displacement signals in the two respective directions (first and second directions), if the wobbling in the first direction is finished and the wobbling in the second direction is then started, it is necessary to start wobbling in the second direction after the wobbling in the first direction has attenuated to some extent. Consequently, there is such a problem that a relatively long time period is required for detecting the displacement, thus, quick control cannot be achieved, and the position cannot be well controlled as a result.

Additionally, in the apparatus as in the above-mentioned publication, it is common to wobble the optical fiber at the minimum required wobbling frequency to follow displacements of the laser beam and the optical fiber due to external forces. However, according to the above-mentioned publication, to distinguish the wobbling in the two directions, the optical fiber is wobbled at different frequencies in the first and second directions, respectively. As a result, it is necessary to wobble the optical fiber at a frequency higher than the minimum required wobbling frequency in at least one of the first and second directions. Consequently, the electric power consumption and the amount of generated heat may increase.

Further, according to the above-mentioned publication, if the relative displacement between the laser beam and the optical fiber becomes large, the rough movement control mechanism providing the large wobbling amplitude is employed. However, the above-mentioned publication does not provide a specific description of the rough movement control mechanism, and thus, feasibility thereof is not clear.

### SUMMARY OF THE INVENTION

The present invention is advantageous in that a two-dimensional position control method and a two-dimensional position control apparatus are provided, which enable a quick two-dimensional position control at the minimum required wobbling frequency, and efficiently decrease a large relative displacement between two objects to be controlled.

According to an aspect of the present invention, there is provided a two-dimensional position control method including a step of oscillating at least either a space propagation energy distributed in a substantially limited range on a predetermined two-dimensional plane or energy input system to which the energy is input where a locus of a relative movement thereof forms an ellipse on the two-dimensional plane, a step of detecting the energies at at least two pairs of points on the elliptic locus on both sides of the center of the ellipse, and a step of calculating differences between the detected energies at the respective pairs of points, thereby detecting a displacement between the energy and the energy input system on the two-dimensional plane. There is also provided a two-dimensional position control method, where the above three steps are repeated until the respective differences between the detected energies reach a predetermined values.

Optionally, in the above two-dimensional position control method, the pair of points may be located symmetrically about the center of the ellipse. In this configuration, it is possible to detect a displacement in a direction parallel to a line connecting the pair of points with each other.

Additionally, the above two-dimensional position control method further includes a step of scanning either the energy or the energy input system within a predetermined area on the two-dimensional plane, where if a difference between the energies within a predetermined range is detected in the scanning step, information on positions corresponding to the difference between the energies is obtained.

According to another aspect of the present invention, there is provided a two-dimensional position control apparatus including an energy output system that outputs a space propagation energy distributed in a substantially limited range on a predetermined two-dimensional plane, an energy input system to which the energy is input, an oscillating system that oscillates at least either the energy or the energy input system such that a locus of the relative movement thereof forms an ellipse on the two-dimensional plane, an energy detecting system that detects energies at at least two pairs of points on the elliptic locus on both sides of the center of the ellipse, and a displacement detecting system that calculates differences between the detected energies at the respective pairs of points, thereby detecting a displacement between the energy and the energy input system on the two-dimensional plane. Additionally, the two-dimensional position control apparatus may further includes a control system that carries out negative feedback control such that the difference between energies detected by the displacement detecting system reaches a predetermined value.

Additionally, in the above two-dimensional position control apparatus, the energy detecting system may detect points symmetrical about the center of the ellipse as the pair of points.

Further, in the above two-dimensional position control apparatus, the oscillating system may move either the energy output system or the energy input system in a first direction, and a second direction orthogonal to the first direction on the two-dimensional plane such that a locus of the combined movements in the two directions forms the ellipse.

Optionally, in the above two-dimensional position control apparatus, the displacement detecting system may detect the displacement in a direction parallel to a line connecting the pair of points with each other. Further, with this configuration, the energy detecting system may detect the respective points such that at least two lines connecting the pair of points with each other are parallel to at least the first direction or the second direction orthogonal to the first direction on the two-dimensional plane.

Furthermore, in the above two-dimensional position control apparatus, the energy may be a light flux presenting a Gaussian distribution, and the at least two pairs of points may be obtained to detect a center position of the light flux. With this configuration, the energy input system may be an optical fiber having a core diameter approximately equal to the diameter of the light flux. Further, with this configuration, the two-dimensional plane may be an incident end surface of the optical fiber upon which the light flux falls.

Additionally, the above two-dimensional position control apparatus may further include a scanning system that scans either the energy or the energy input system within a predetermined area on the two-dimensional plane, and a position information obtaining system that obtains information on positions corresponding to a difference between energies if the difference between the energies is within a predetermined range based on the energies detected by the scanning system during the scan of the energy or the energy input system.

### BRIEF DESCRIPTION OF THE ACCOMPANYING DRAWINGS

FIG. 1 schematically shows a configuration of a beam position controlling unit according to a first embodiment of the invention;

FIG. 2 shows a chart indicating a movement of laser beam on an end surface of an optical fiber, when the laser beam is wobbled, according to the first embodiment of the invention;

FIG. 3 is a chart showing a temporal change of a signal output when the wobbling is carried out according to the first embodiment of the invention;

FIG. 4 is a flowchart showing an overall procedure of two-dimensional position control according to the first embodiment of the invention;

FIG. 5 shows a flowchart illustrating a subroutine, which is called in FIG. 4, carrying out a servo procedure;

FIGS. 6 and 7 show a flowchart illustrating a subroutine of a positioning procedure, which is called in FIG. 5;

FIG. 8 shows a flowchart illustrating a subroutine of a core center detecting procedure, which is called in FIG. 5, according to the first embodiment of the invention;

FIG. 9 shows a chart illustrating the core center detecting procedure;

FIG. 10 schematically shows a configuration of a beam position controlling unit according to a second embodiment of the invention;

FIG. 11 shows a flowchart illustrating a subroutine of a core center detecting procedure, which is called in FIG. 5, according to the second embodiment of the invention;

FIG. 12 schematically shows a configuration of a beam position controlling unit according to a third embodiment of the invention;

FIG. 13 schematically shows a configuration of an actuator unit serving as a component of the third embodiment of the present invention; and

FIG. 14 schematically shows a configuration of a beam position controlling unit according to a fourth embodiment of the invention.

### DETAILED DESCRIPTION OF THE EMBODIMENTS

Hereinafter, referring to the accompanying drawings, a two-dimensional position control apparatus according to a first embodiment of the present invention will be described.

### First Embodiment

The two-dimensional position control apparatus according to the first embodiment of the present invention is configured such that an energy which is output from an output source and propagates in a space (hereinafter simply referred to as a space propagation energy) is input to a device (hereinafter simply referred to as a space propagation energy receiving system). Then, the two-dimensional position control apparatus positions the space propagation energy and the space propagation energy receiving system with respect to each other based on an output obtained from the space propagation energy receiving system. The two-dimensional position control apparatus is employed, for example, as a laser beam input module of a CPE (Customer Premises Equipment) for optical communication used for transmission/reception of data over optical cables at general households and the like.

In the present invention, the detected quantity of the space propagation energy varies according to a displacement between the position of the space propagation energy and the position of the space propagation energy receiving system. Although the present embodiment employs laser beam as the space propagation energy, according to an alternative embodiment, the two-dimensional position control apparatus may be configured such that a sound wave or electromagnetic wave may be employed as the space propagation energy. It should be noted that the space propagation energy (laser beam in the present embodiment) is referred to as a signal in the present invention.

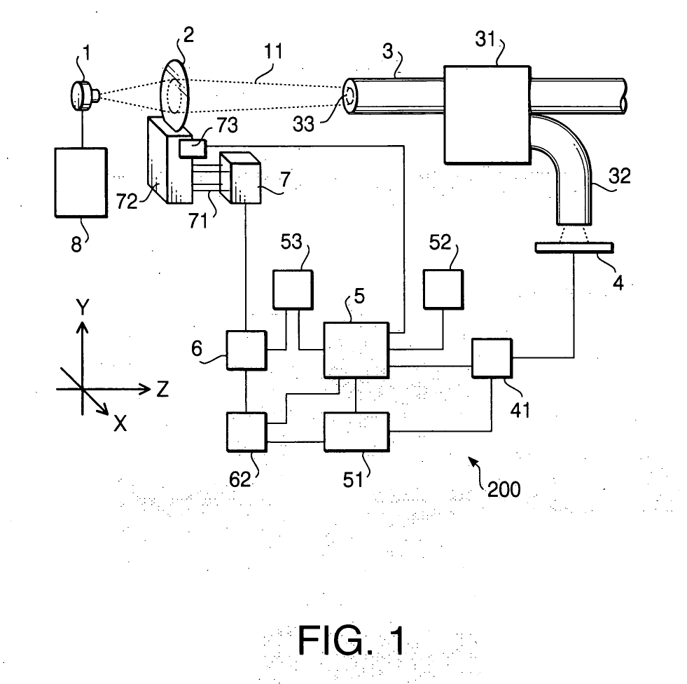

FIG. 1 schematically shows the configuration of a laser beam input module 200 according to the first embodiment of the present invention. A description will now be given of the configuration and an operation of the laser beam input module 200 with reference to FIG. 1.

The laser beam input module 200 is configured such that a laser beam 11 is input to an optical fiber 3 of a transmission/reception section of the CPE for the optical communication. The laser beam input module 200 includes a laser diode 1 which emits the laser beam 11, an objective lens 2 disposed in front of the laser diode 1, the optical fiber 3 disposed in front of the objective lens 2, a beam splitter 31 provided to (within the optical path of) the optical fiber 3, a split optical fiber 32 which is a split path of the beam splitter 31, a photodetector 4 disposed adjacent to an end of the split optical fiber 32, an amplifier 41 connected to the photodetector 4 to amplify the output of the photodetector 4, a control unit 5 which manages overall control of the laser beam input module 200, a clock 51 which generates timing signals for various controls, a memory 52 which stores various information, data retaining device 53 (e.g., RAM: Random Access Memory) which temporarily retains the various information, an actuator driving amplifier 6 which serves as a driver for driving an actuator 7, a wobbling module 62 which controls an oscillating (wobbling) operation carried out by the actuator 7 which moves the objective lens 2, a support spring 71 one end of which is fixed to a fixing section of the actuator 7, a lens holder 72 which holds the objective lens 2 fixed to the support spring 71, a position sensor 73 which detects the position of the objective lens 2, and a laser diode driving device 8 which serves as a driver for driving the laser diode 1.

It should be noted an orthogonal coordinate system is defined such that a Z direction denotes a direction parallel to the optical axis of the objective lens 2, a Y direction denotes a direction orthogonal to the Z axis and parallel to a plane of FIG. 1, and an X direction denotes a direction orthogonal both to the Y and Z directions in FIG. 1.

The laser diode 1 driven by the laser diode driving device 8 emits the laser beam 11. The emitted laser beam 11 is incident on a core 33 on the end surface of the optical fiber 3 via the objective lens 2. It should be noted that the objective lens 2 focuses the laser beam 11 on the end surface of the optical fiber 3 such that the light quantity of the laser beam 11 incident on the core 33 is equal to or more than a predetermined quantity.

The laser beam 11 transmitted through the core 33 is partially directed to the split optical fiber 32, by the splitter 31, at a predetermined ratio. The laser beam 11 transmitted through the split optical fiber 32 emerges from the split optical fiber 32, and then, enters the photodetector 4.

The photodetector 4 receives the incident laser beam 11 (more specifically, the light quantity of the laser beam 11 split at the predetermined ratio by the splitter 31) and output a signal representing the quantity of the received light (which corresponds to the light quantity of the laser beam 11). A signal output from the photodetector 4 is transmitted to and amplified by the detected light amplifier 41.

The control unit 5 detects and outputs various signals synchronously with the timing signals generated by the clock 51. When the amplifier 41 outputs an amplified signal, the control unit 5 acquires the output signal at predetermined timing points within the wobbling cycle. The control unit 5 detects a displacement of the laser beam 11 from the core 33 on the end surface of the optical fiber 3 based on the acquired signal, and outputs signals, which are used to drive the actuator driving amplifier 6, to the data retaining device 53. In addition, the control unit 5 also serves to control the wobbling module 62.

The wobbling module 62 outputs signals which are used to drive the actuator 7 at a predetermined frequency of “f” and a predetermined amplitude of “a” to the actuator driving amplifier 6 under the control of the control unit 5.

The actuator driving amplifier 6 drives the actuator 7 based on the signals output by the data retaining device 53 and the signals output by the wobbling module 62. When the actuator 7 is driven, a movable end (i.e., the left-hand side end in FIG. 1) of the support spring 71 that is fixed to the actuator 7, the lens holder 72 supported by the support spring 71, and the objective lens 2 held by the lens holder 72 move integrally. The actuator 7 also serves as a scanning system which continuously moves the objective lens 2 in a predetermined limited range in an X-Y plane.

The support spring 71 includes four parallel metal springs with a circular cross section whose longitudinal direction in a neutral state coincides with the Z direction. The four metal springs have such characteristics that they are displaced relatively easily in the X and Y directions, and are hardly displaced in the Z direction when an external force is applied thereto.

The lens holder 72 is supported by the support spring 71. Thus, the objective lens 2 and the lens holder 72 are wobbled by the drive of the actuator 7, which exhibits an oscillation characteristic of a second order delay system.

The position sensor 73 is disposed adjacent to the lens holder 72. The position sensor 73 detects the displacements of the lens holder 72 in the X and Y directions, respectively. A signal representing each of the displacements detected by the position sensor 73 is transmitted to the control unit 5. Accordingly, the control unit 5 obtains position information of the objective lens 2 based on the signal transmitted from the position sensor 73.

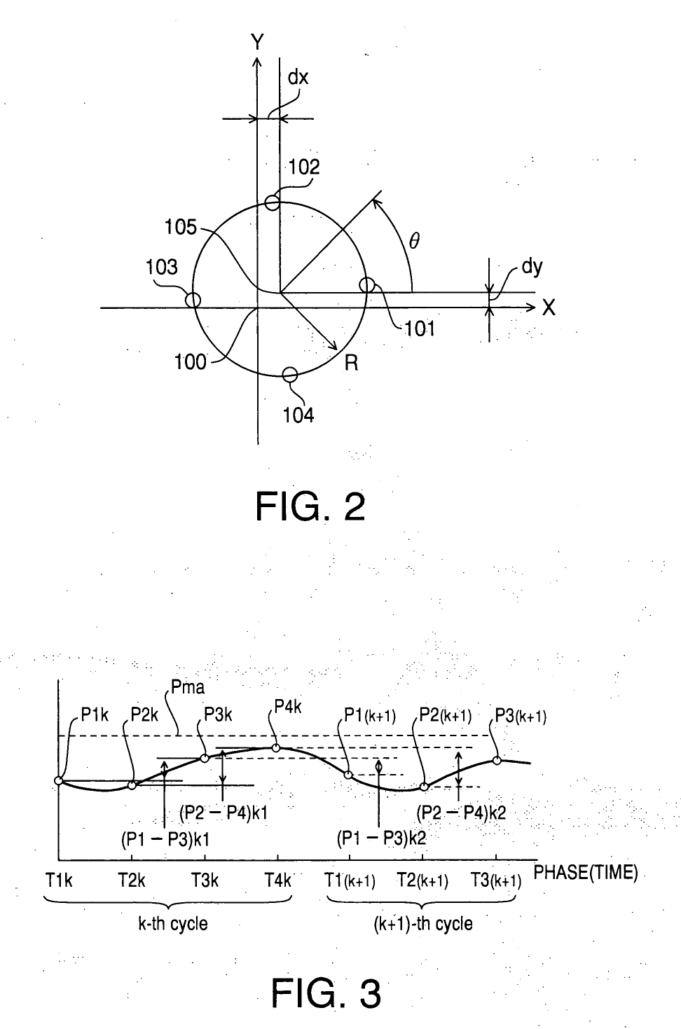

FIG. 2 is a chart illustrating a movement of the laser beam 11 on the end surface of the optical fiber 3 when the laser beam 11 is wobbled according to the first embodiment of the present invention. According to the first embodiment, the objective lens 2 is wobbled by the actuator 7 such that the locus of the objective lens 2 forms a circle, and the laser beam 11 is wobbled to form a circle on the end surface of the optical fiber 3.

An X axis and a Y axis in FIG. 2 correspond to the X direction and the Y direction in FIG. 1, respectively. The intersection of the X axis and Y axis in FIG. 2 coincides with the center of the core 33 (core center 100), and the laser beam 11 is wobbled on the end surface of the optical fiber 3 with forming the circle having a radius of R about a rotation center 105. It should be noted that, according to the embodiment, the rotation center 105 is the center of the laser beam 11 when the laser beam 11 is not wobbled, and is positioned at a point displaced by dx in the X direction, and by dy in the Y direction from the core center 100 (at a coordinate (dx, dy) where the core center 100 is at the origin). It should be noted that since a circle is a special form of an ellipse where the two focuses of the ellipse coincide with each other, a circle herein is considered as one of elliptical shapes. Additionally, although the laser beam 11 in the present embodiment forms a circular locus, the objective lens 2 may be wobbled such that the laser beam 11 forms an elliptic locus in another embodiment. In such a case, the rotation center 105 is defined as a mid point between the two focuses of the ellipse.

Points 101, 102, 103, and 104 represent sampled points of the locus of the center of the laser beam 11 when being wobbled. Specifically, the point 101 is a point in the vicinity of an intersection between a line starting from the rotation center 105 in parallel with the X axis, and the above-described circle, and the point 103 is a point symmetrical to the point 101 on the circle with respect to the rotation center 105. The point 102 is a point in the vicinity of an intersection between a line starting from the rotation center 105 in parallel with the Y axis, and the circle, and the point 104 is symmetrical to the point 102 with respect to the rotation center 105.

An intensity distribution of the laser beam 11 generally exhibits a Gaussian distribution across its diameter. The respective components (the laser diode 1, the objective lens 2 and the optical fiber 3) are disposed such that the diameter (diameter at which the light intensity is 1/e² of that of the center) of the laser beam 11 on the end surface is approximately equal to the diameter (approximately 10 μm) of the core 33.

The light quantity of the laser beam 11 incident on the core 33 is maximized when the center of the laser beam 11 coincides with the center of the core 33, and decreases as the displacement therebetween increases. In a range where the displacement is relatively small, the quantity of the light incident on the core 33 generally decreases in proportional to the square of the displacement. A cross sectional shape of the laser beam 11 is generally an ellipse on the X-Y plane. Note that the cross sectional shape is a circle if the laser diode 1 is a surface emitting diode. A description given herein assumes the cross sectional shape of the laser beam 11 is a circle on the X-Y plane.

The following equations represent respective drive currents in the X and Y directions where the center of the laser beam 11 is adjusted so as to approximately coincide with the center of the core 33 when the currents are not supplied to the actuator 7. It should be noted that an oscillation characteristic and a generated acceleration for a unit current (acceleration sensitivity) are the same both in the X and Y directions in the actuator 7.
Iₓ=Iₒ×sin(2×π×f×t) (1)
I_{y}=Iₒ×sin(2×π×f×t+π/2) (2)

FIG. 3 is a chart showing a temporal change of the signal output when the wobbling is carried out according to the first embodiment. The vertical axis represents the quantity of the signal output, and the horizontal axis represents the phase (time). FIG. 3 shows the temporal change of the signal output in the k-th and (k+1)-th cycles of the laser beam 11. The signal outputs detected at the points 101, 102, 103 and 104 by the photodetector 4 are represented respectively as P1, P2, P3 and P4, and the signal output changes as the laser beam 11 goes through one cycles thereof as shown in FIG. 3. T1ₖ, T2ₖ, T3ₖ, and T4ₖ represent time points at which the laser beam 11 passes the points 101, 102, 103 and 104, respectively, in the k-th cycle. Similarly, T1₍ₖ₊₁₎, T2₍ₖ₊₁₎, T3₍ₖ₊₁₎, and T4₍ₖ₊₁₎ represent time points at which the laser beam 11 passes the points 101, 102, 103 and 104, respectively, in the (k+1)-th cycle. P1ₖ, P2ₖ, P3ₖ and P4ₖ represent the signal outputs of the laser beam 11 at the points 101, 102, 103 and 104 in the k-th cycle, respectively. Similarly, P1₍ₖ₊₁₎, P2₍ₖ₊₁₎, P3₍ₖ₊₁₎ and P4₍ₖ₊₁₎ represent the signal outputs of the laser beam 11 at the points 101, 102, 103 and 104 in the (k+1)-th cycle, respectively.

Under the above-described condition where the quantity of the laser beam 11 incident on the core 33 decreases approximately in proportional to the square of the displacement “r” of the center of the laser beam 11 with respect to the core center 100, the difference in the signal output P between P1 and P3 is represented as:
P=Q₀×(1−k×r²) (3)
where k is a coefficient.

When the origin of the coordinate system is set at the rotation center 105, and the coordinates of the points 101 and 103 are represented as (x₀₁, y₀₁) and (x₀₃, y₀₃), since the points 101 and 103 are symmetrical with respect to the rotation center 105 on the X-Y plane and are different in phase from each other by 180 degrees, the coordinate of the point 101 (x₁, y₁) and the coordinate of the point 103 (x₃, y₃) in the coordinate system having the core center 100 as the origin are represented as:
x₁=x₀₁+dx (4)
y₁=y₀₁+dy (5)
x₃=−x₀₁+dx (6)
y₃=−y₀₁+dy (7)
Assigning these equations (4) through (7) to (3) taking a relationship r²=x²+y² into account, the difference P1-P3 is calculated as follows.

$$\begin{matrix}P1 - P3 = {Q}_{0} \times ( - k \times ( {x}_{1}^{2} + {y}_{1}^{2} ) + k \times ( {x}_{3}^{2} + {y}_{3}^{2} ) ) \\ = - {Q}_{0} \times k \times ( {( {x}_{01} + dx )}^{2} + {( {y}_{01} + dy )}^{2} - \\ {( - {x}_{01} + dx )}^{2} - {( - {y}_{01} + dy )}^{2} ) \\ = - {Q}_{0} \times k \times 4 \times ( {x}_{01} \times dx + {y}_{01} \times dy )\end{matrix} \qquad ( 8 )$$

As the equation (8) clearly shows, in the detection of the displacement in the X direction between the core 33 and the laser beam 11, the smaller the absolute value of y₀₁ becomes, the higher precision the displacement is detected at in the X direction. Namely, if the line connecting the point 101, the rotation center 105, and the point 103 is parallel with the X axis (y₀₁=0, for example), the equation (8) will represent a value proportional to the displacement dx in the X direction. Thus, the displacement in the X direction is obtained at the highest accuracy according to the difference in the signal output (P1-P3) obtained in this case. It should be noted that the smaller the absolute value of the difference in the signal output (P1-P3) becomes, the closer the rotation center 105 approaches the core center 100 in the X direction, while, the larger the absolute value becomes, the farther the rotation center 105 departs from the core center 100 in the X direction.

In order that the control unit 5 obtains the output of the photodetector 4 at a moment when the laser beam 11 is present on the point 101, the control unit 5 retains time delays of the objective lens 2 with respect to the drive signal output from the control unit 5 as a data table to drive the actuator 7. The control unit 5 uses this table to correct the time delay (in advance), and obtains the output of the photodetector 4.

Similarly to the above description, when the origin of the coordinate system is at the rotation center 105 and coordinates of the points 102 and 104 are represented as (x₀₂, y₀₂) and (x₀₄, y₀₄), the difference in the signal output between P2 and P4 is calculated as:
P2-P4=−Q₀×k×4×(x₀₂×dx+y₀₂×dy) (9)

As the equation (9) clearly shows, when detecting the displacement, in the Y direction, between the core 33 and the laser beam 11, the smaller the absolute value of x₀₂ becomes, the higher precision the displacement is detected at in the Y direction. Namely, if the line connecting the point 102, the rotation center 105, and the point 104 is parallel with the Y axis (x₀₂=0, for example), the equation (9) will represent a value proportional to the displacement dy in the Y direction. Thus, the displacement in the Y direction is obtained at the highest accuracy according to the difference in the signal output (P2-P4) obtained in this case. It should be noted that the smaller the absolute value of the difference in the signal output (P2-P4) becomes, the closer the rotation center 105 approaches the core center 100 in the Y direction, while, the larger the absolute value becomes, the farther the rotation center 105 departs from the core center 100 in the Y direction.

In the above-described situation, if the clock is set such that the count of the clock used for driving the wobbling module 62 is set to an integer multiple of four in one cycle, and the count coincides with the timing when the laser beam 11 is positioned by the objective lens 2 at any one of the four positions such as the point 101, it is possible to restrain a displacement in the position detection caused by the shift of the timing. The control signal output from the control unit 5 to the wobbling module 62 is a signal for controlling the objective lens 2 to wobble at the frequency “f” and the amplitude “a”, and characteristics of the actuator driving amplifier 6, the actuator 7 and the support spring 71 are stable. As a result, variations of the positions ((x₀₁, y₀₁), (x₀₂, y₀₂), (x₀₃, y₀₃) and (x₀₄, y₀₄)) of the laser beam 11 with respect to the rotation center 105 are sufficiently small.

The control unit 5 divides the signal output from the position sensor 73 into components in the two directions (X and Y directions), differentiates the each of the components with respective to time, amplifies the differentiated results, and overlaps the amplified results on the drive signals for the actuator driving amplifier 6. This can efficiently attenuate a mechanical resonance of the actuator 7. In this case, the signals differentiated with respect to time are filtered such that the signals are sufficiently small at the wobbling frequency, and are attenuated in a high frequency region. Therefore, the differentiated signals do not affect the signals used for wobbling the objective lens 2.

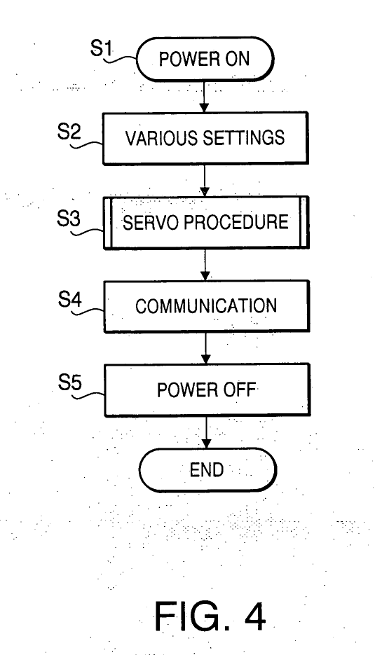

A description will now be given of the position control processing according to the first embodiment of the present invention with reference to FIGS. 4 through 8.

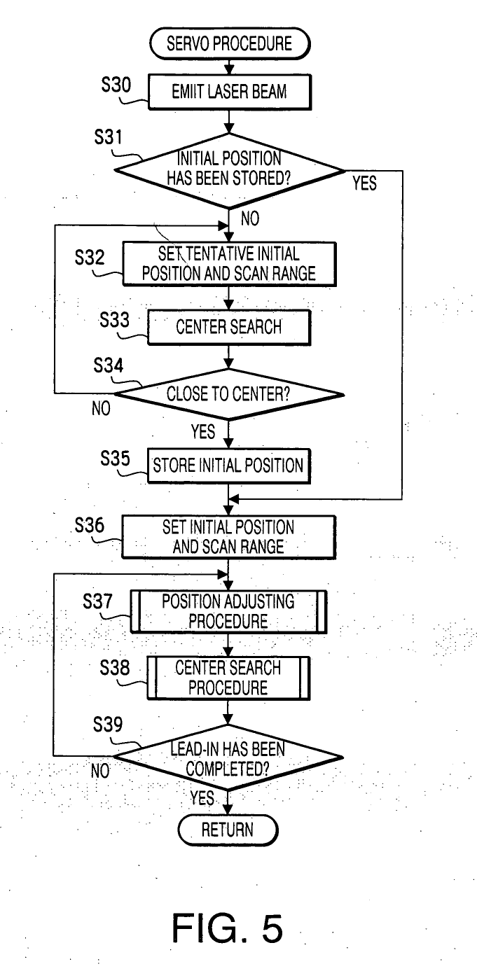

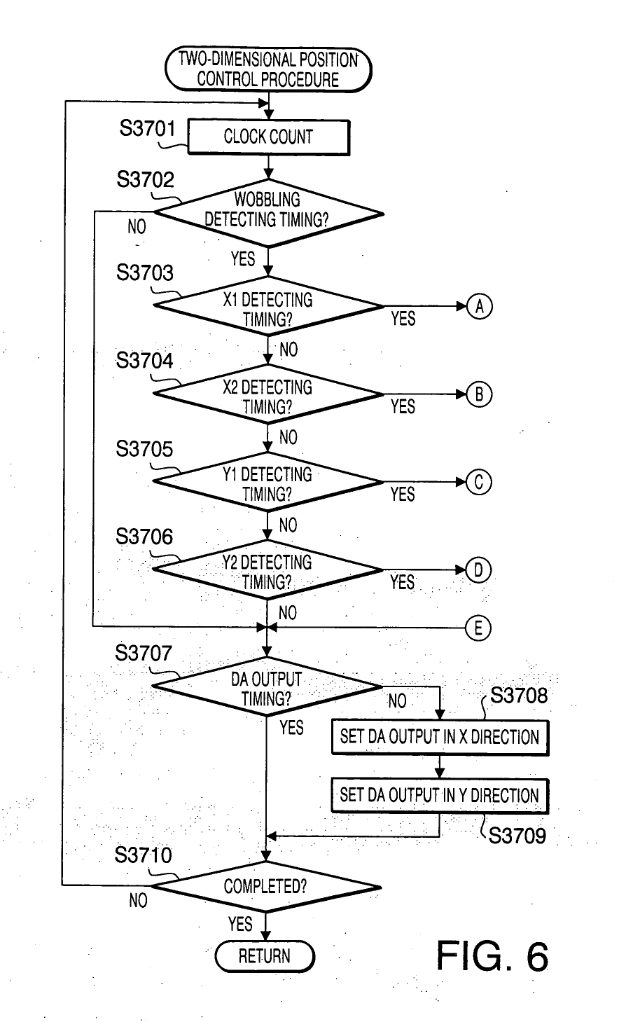

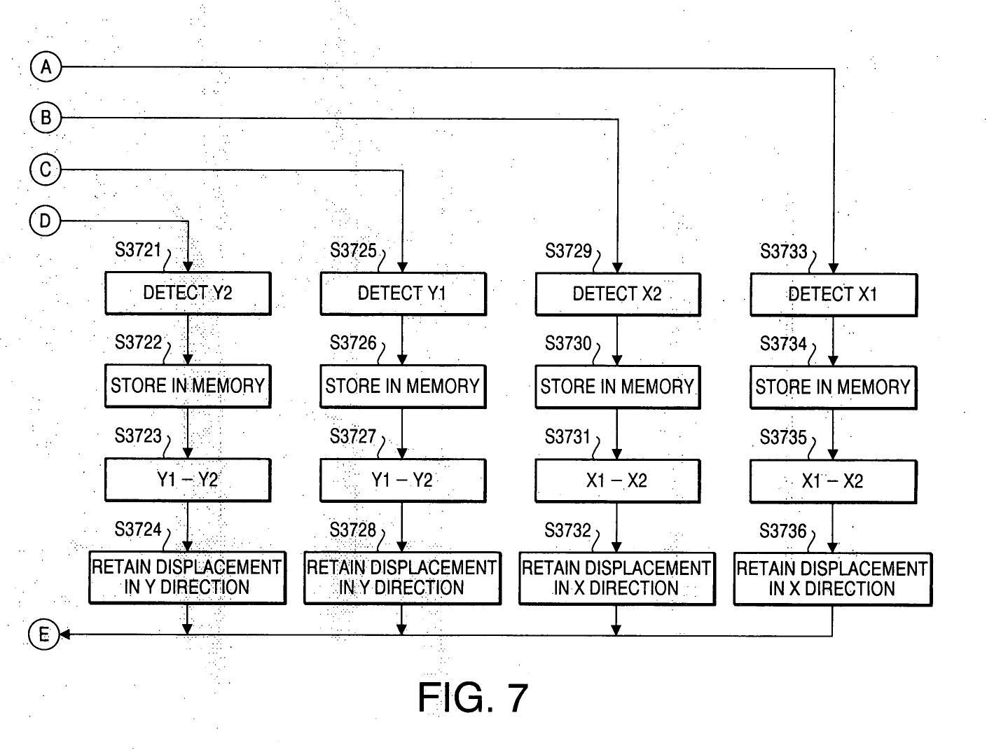

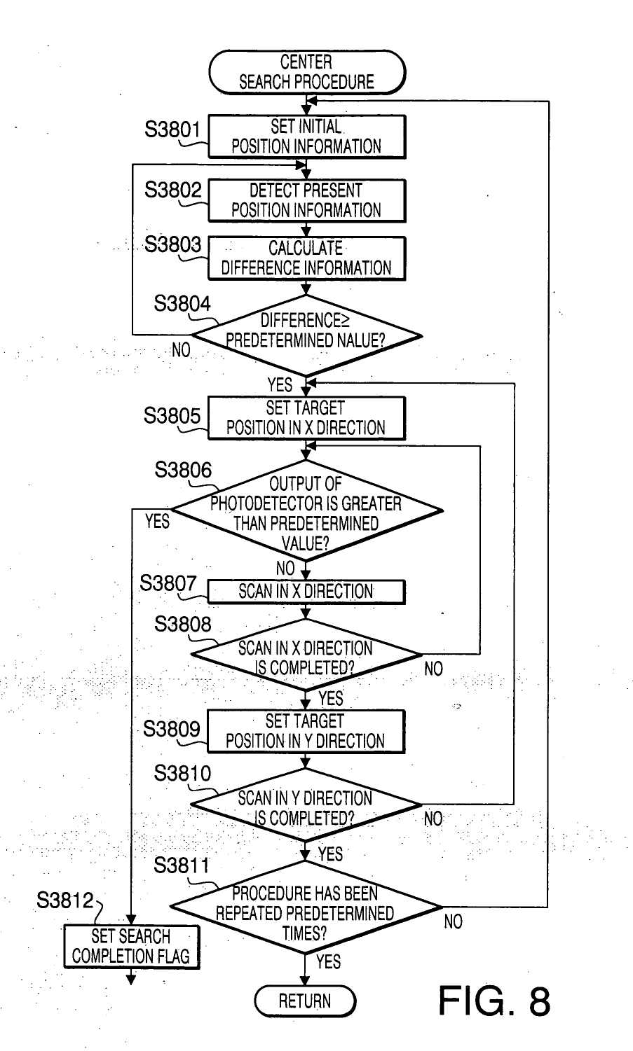

FIG. 4 is a flowchart showing an overall flow of the position control procedure according to the first embodiment. FIG. 5 is a flowchart showing a subroutine “servo procedure” which is called in FIG. 4. FIGS. 6 and 7 show a flowchart illustrating a subroutine of a “two-dimensional position control procedure” by means of the wobbling according to the first embodiment of the invention. FIG. 8 is a flowchart showing a subroutine in FIG. 5 describing search procedure for the core center according to the first embodiment of the invention.

First, a description will be given of the overall flow of the position control procedure according to the first embodiment of the present invention with reference to FIG. 4.

The position control procedure is started when the laser input module 200 is powered on. If the CPE for the optical communication including the laser beam input module 200 as the component thereof is turned on, (Step 1, hereinafter “Step” is simply referred to as “S”), the control unit 5 sets operational parameters/conditions used for operating the laser input module 200 (S2). After the setting, the control unit 5 is ready for the position control for the core 33 and the laser beam 11 in the laser beam input module 200, and positions the laser beam 11 with respect to the optical fiber 3. Namely, the control section carries out the servo procedure for adjusting the relative position between the core 33 and the laser beam 11 (S3).

After the positioning between the core 33 and the laser beam 11 has been completed in the servo procedure in S3, the control unit 5 provides a user with a notice, using a display (not shown), that the optical communication is now available, and simultaneously, controls the transmission/reception according to requests from the user and/or the outside (S4). If the user carries out a power-off operation, the control unit 5 stores necessary information in the memory 52, and then, turns off the leaser beam input module 200 (S5).

FIG. 5 shows the detailed operations of the servo processing called in S3 of FIG. 4. The control unit 5 firstly drives the laser diode drive device 8 to cause the laser diode 1 to emit the laser beam 11 (S30). The control unit 5 further checks whether position information which is obtained when the position of the laser beam 11 with respect to the optical fiber 3 is adjusted (i.e., information on the center position of the core 33, namely initial position information in this case) is stored on the memory 52 (S31).

If the initial position information is stored in the memory 52 (S31: YES), the control unit 5 proceeds to S36. If the initial position information is not stored in the memory 52 (e.g., in a case where the laser beam input module 200 has not yet been operated after being manufactured) (S31: NO), the control unit 5 sets a tentative initial position and a tentative scan range (S32). The tentative initial position herein means a position on the end surface of the optical fiber 3 from which the scan of the laser beam 11 starts during a center search procedure in S33 described below. The tentative scan range means a part of a possible scan range of the laser beam 11, which is, for example, one of divided ranges of the possible scan range.

The control unit 5 causes the laser beam 11 to scan starting from the tentative initial position in the tentative scan range, thereby searching for the center of the core 33 (S33). In this case, if a part of the laser beam 11 is incident on the core 33, the output of the photodetector 4 changes.

The control unit 5 determines whether the position of the laser beam 11 on the end surface of the optical fiber 3 is close to the core 33 based on whether the output of the photodetector 4 is greater than a predetermined value (S34). If the output of the photodetector 4 is greater than the predetermined value during the scan within the tentative scan range (S34: YES), the control unit 5 determines that the position of the laser beam 11 is close to the core 33. The control unit 5 then converts the outputs of the position sensor 73 in the two directions (X and Y directions) at the detected position to the position information of the objective lens 2, and stores the converted position information as an initial position in the memory 52 (S35). If the outputs equal to or less than the predetermined value are detected during the scan in the tentative scan range (S34: NO), the control unit 5 determines that the position of the laser beam 11 is not close to the core 33, and the control unit 5 returns to S32. In S32, the control unit 5 sets a new tentative initial position and a tentative scan range different from the previous ones to continue the center search procedure.

In step S36, the control unit 5 sets the initial position stored in the memory 52 (namely the previously obtained initial position) and a scan range as operational parameters. It should be noted that the initial position set at this stage is close to the core 33. Since the control unit 5 has recognized that the initial position is close to the core 33, the scan range set in this step may be relatively narrow (narrower than the tentative scan range in S32, for example).

After setting the initial position and the scan range, the control unit 5 starts the wobbling to carry out the servo procedure for the adjustment of the relative positions between the core 33 and the laser beam 11 in the X and Y directions (S37). A description will now be given of the servo procedure for the two-dimensional position control by means of the wobbling in S37 (FIG. 5) with reference to FIGS. 6 and 7.

If a predetermined timing of the clock generated by the clock 51 is used as timing for the position control by means of the wobbling, the control unit 5 counts the clock (S3701). Then, the control unit 5 determines, based on the count, whether the timing is a timing at which the output of the photodetector 4 is to be detected (S3702). If this timing is not the timing to detect the output of the photodetector 4 (S3702: NO), the control unit 5 proceeds to S3707. If this timing is the timing to detect the output of the photodetector 4 (hereinafter simply referred to as wobbling detection timing) (S3702: YES), the control unit 5 proceeds to step S3703.

The control unit 5 determines whether the present timing is the wobbling detection timing for the point 101 in S3703. Namely, the control unit 5 determines whether the present timing is the timing at which the laser beam 11 is positioned on the point 101, and the output of the photodetector 4 is thus to be detected.

If the present timing is the wobbling detection timing for the point 101 (S3703: YES), the control unit 5 proceeds to S3733 in FIG. 7, and then, detects the output of the photodetector 4. Then, the control unit 5 stores a detection result as “X1” in the memory 52 (S3734). The control unit 5 further calculates the difference between “X2” (the output signal detected at the wobbling detection timing for the point 103), which is stored in the memory 52 by processing described later, and “X1”, which is the detection result for the present time, to determine the displacement ΔX in the X direction (S3735), causes the memory 52 to retain ΔX until the next ΔX is calculated (S3736), and proceeds to S3707 in FIG. 6. If “X2” is not stored in the memory 52, the control unit 5 proceeds to S3707 in FIG. 6 without carrying out the steps S3735 and S3736.

If the present timing is not the wobbling detection timing for the point 101 (S3703: NO), the control unit 5 proceeds to S3704, and determines whether the present timing is the wobbling detection timing for the point 103. Namely, the control unit 5 determines whether the present timing is the timing at which the laser beam 11 is positioned on the point 103, and the output of the photodetector 4 is thus to be detected.

If the present timing is the wobbling detection timing for the point 103 (S3704: YES), the control unit 5 proceeds to S3729 in FIG. 7, and then, detects the output of the photodetector 4. Then, the control unit 5 stores a detection result as “X2” in the memory 52 (S3730). The control unit 5 further calculates the difference between “X1”, which is stored in the memory 52, and “X2”, which is the detection result for the present time, to determine the displacement ΔX in the X direction (S3731), causes the memory 52 to retain ΔX until the next ΔX is calculated (S3732), and proceeds to S3707 in FIG. 6. If “X1” is not stored in the memory 52, the control unit 5 proceeds to S3707 in FIG. 6 without carrying out the steps S3731 and S3732.

In the above case, if a target position in the X direction (namely, the center of the core 33 in the X direction) is X0, the control unit 5 carries out the feedback employing ΔX-X0 as a signal representing the displacement between the center of the core 33 and the center of the laser beam 11 (in other words, the core center 100 and the rotation center 105) in the X direction to drive the actuator driving amplifier 6.

Alternatively, if the present timing is not the wobbling detection timing for the point 103 (S3704: NO), the control unit 5 proceeds to S3705, and determines whether the present timing is the wobbling detection timing for the point 102. Namely, the control unit 5 determines whether the present timing is the timing at which the output of the photodetector 4 is detected when the laser beam 11 is positioned on the point 102.

If the present timing is the wobbling detection timing for the point 102 (S3705: YES), the control unit 5 proceeds to S3725 in FIG. 7, and then, detects the output of the photodetector 4. Then, the control unit 5 stores a detection result as “Y1” in the memory 52 (S3726). The control unit 5 further calculates the difference between “Y2” (the output signal detected at the wobbling detection timing for the point 104), which is stored in the memory 52 by processing described later, and “Y1”, which is the detection result for the present time, to determine the displacement ΔY in the Y direction (S3727), causes the memory 52 to retain ΔY until the next ΔY is calculated (S3728), and proceeds to S3707 in FIG. 6. If “Y2” is not stored in the memory 52, the control unit 5 proceeds to S3707 in FIG. 6 without carrying out the steps S3727 and S3728.

If the present timing is not the wobbling detection timing for the point 102 (“NO” in S3705), the control unit 5 proceeds to S3706, and determines whether the present timing is the wobbling detection timing for the point 104. Namely, the control unit 5 determines whether the present timing is the timing at which the laser beam 11 is positioned on the point 104, and the output of the photodetector 4 is thus to be detected.

If the present timing is the wobbling detection timing for the point 104 (S3706: YES), the control unit 5 proceeds to S3721 in FIG. 7, and then, detects the output of the photodetector 4. Then, the control unit 5 stores a detection result as “Y2” onto the memory 52 (S3722). The control unit 5 further calculates the difference between “Y1”, which is stored on the memory 52, and “Y2”, which is the detection result for the present time, to determine the displacement ΔY in the Y direction (S3723), causes the memory 52 to retain ΔY until the next ΔY is calculated (S3724), and proceeds to S3707 in FIG. 6. If “Y1” is not stored on the memory 52, the control unit 5 proceeds to S3707 in FIG. 6 without carrying out the steps S3723 and S3724.

In this case, if a target position in the Y direction (namely, the center of the core 33 in the Y direction) is Y0, the control unit 5 carries out feedback employing ΔY-Y0 as a signal representing the displacement between the center of the core 33 and the center of the laser beam 11 (in other words, the core center 100 and the rotation center 105) in the Y direction to drive the actuator driving amplifier 6.

In S3707, the control unit 5 determines whether the present timing is timing at which the control unit 5 outputs data (DA data) to the data retaining device 53 which retains output instruction values other than those for the wobbling or to the wobbling means 62. If the present timing is the timing of the output of the DA data (S3707: YES), the control unit 5 sets internally calculated DA output data in the X direction corresponding to the drive current for the actuator 7 to the data retaining device 53 or the wobbling means 62 (S3708), further sets DA output data in the Y direction to the data retaining device 53 or the wobbling means 62 (S3709), and proceeds to S3710. The actuator driving amplifier 6 drives the actuator 7 in the X and Y directions by means of the drive currents according to the data set on the data retaining device 53 or the wobbling means 62. If the present timing is not the timing at which the control unit 5 outputs the DA data (S3707: NO), the control section proceeds to S3710. In S3710, the control unit 5 determines whether the servo procedure has been completed or not. If the servo procedure has not been completed (S3710: NO), the control unit 5 returns to S3701 to wait for the next clock input. Alternatively, if the servo procedure has been completed (S3710: YES), the control unit 5 proceeds to procedure for the completion, not shown.

If the servo procedure has been completed in S37, the control unit 5 then carries out the search procedure for the center of the core 33 (S38). A description will now be given of the search procedure for the center of the core 33 in S38 in FIG. 5 with reference to FIG. 8.

The control unit 5 first clears a flag indicating the completion of the search for the center of the core 33, and simultaneously, obtains the initial position information in the X and Y directions stored on the memory 52 in S35 in FIG. 5 (S3801). Then, the control section detects the present position information in the X and Y directions of the objective lens 2 based on the output of the position sensor 73 (S3802), and calculates difference information between the present position information and the initial position information (S3803). The control unit 5 causes the actuator driving amplifier 6 to drive the actuator 7 such that values represented by the present position information output from the position sensor 73 becomes closer to values represented by the initial position information based on the difference information calculated previously. If values represented by the difference information are more than respective predetermined values (namely the present position of the objective lens 2 and the position represented by the initial position information are separated by a predetermined distance) (S3804: NO), the control unit 5 determines that the positioning procedure has not been completed, and thus, returns to S3802. Alternatively, the values represented by the difference information are equal to or less than the respective predetermined values, and simultaneously, this state continues for a predetermined period (S3804: YES), the control unit 5 determines that the positioning procedure has been completed, and thus, proceeds to S3805.

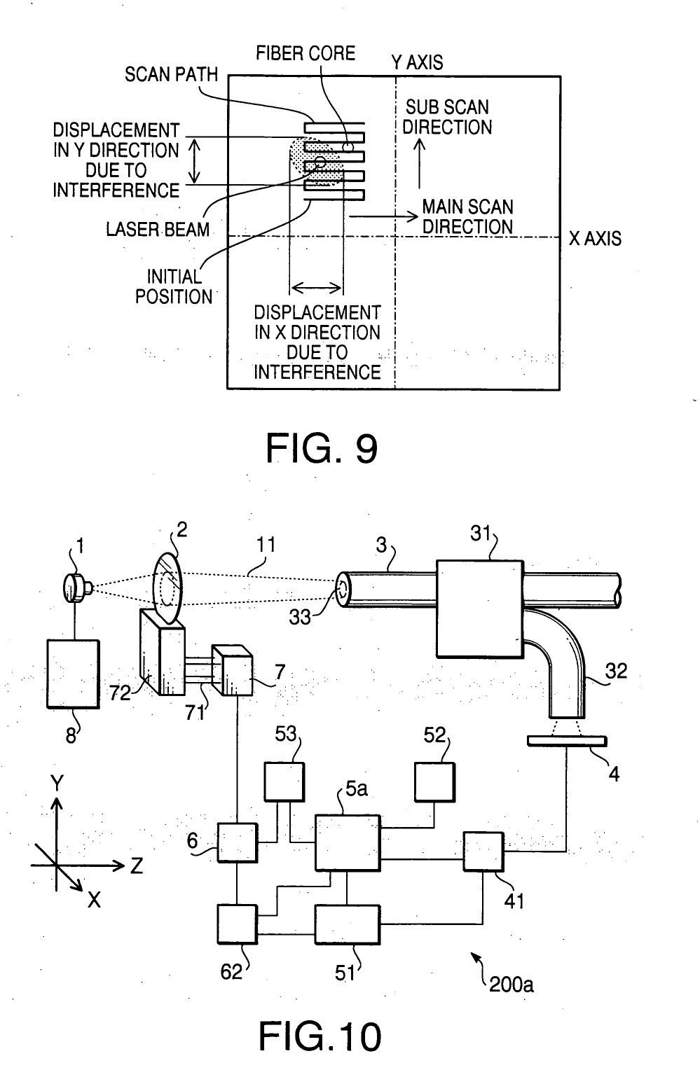

The control unit 5 carries out the procedure of searching for the center of the core 33 in procedure subsequent to S3805 in the flowchart in FIG. 8. In the center search procedure carried out subsequently, the control unit 5 scans the objective lens 2 in the predetermined scan range (range set by the procedure in S36) in the X and Y directions to search for a position where the laser beam 11 falls upon the core 33. FIG. 9 describes the center search procedure carried out on this occasion. It should be noted that the X and Y directions for the scan are defined respectively as a main scan direction, and a sub scan direction in the first embodiment. A description will now be given of the center search procedure according to the first embodiment of the present invention with reference to FIG. 9.

In the center search procedure shown in FIG. 9, the main scan of the laser beam 11 is carried out at a predetermined velocity from a first end (end on the left side in FIG. 9) to a second end (end on the right side in FIG. 9), where the first and second ends are ends in the scan range in the X direction. If the laser beam 11 reaches the second end, the sub scan of the laser beam 11 is carried out in the Y direction by a predetermined distance, and then, the main scan of the laser beam 11 is carried out at the predetermined velocity from the second end to the first end. This series of scans are repeated until the output of the photodetector 4 changes.

As described above, the diameter of the laser beam 11 on the end surface of the optical fiber 3 and the diameter of the core 33 are approximately 10 μm. However, if the position control is not being carried out, the distance between the laser beam 11 and the core 33 largely exceeds 10 μm on the X-Y plane. In this case, the output of the photodetector 4 is approximately 0 (zero). If a part of the laser beam 11 is incident on the core 33, the output of the photodetector 4 takes a limited value according to the center distance between the core 33 and the laser beam 11. Therefore, if the output of the photodetector 4 exceeds the predetermined value, the laser beam 11 is close to the center of the core 33. Thus, it is possible to determine that the center search is successful or not based on whether the output of the photodetector 4 exceeds the predetermined value or not.

In S3805, the control unit 5 sets a target position in the X direction for the main scan of the laser beam 11 from the first end to the second end as described above. The target position in the X direction is the second end if the present position of the laser beam 11 is the first end, and the position is the first end if the present position of the laser beam 11 is the second end. The control unit 5 then determines whether the output of the photodetector 4 exceeds the predetermined value or not (S3806). If the output of the photodetector 4 exceeds the predetermined value (S3806: YES), the control unit 5 sets a flag which indicates that the center search is successful (S3812), and proceeds to S39 in FIG. 5. If the output of the photodetector 4 does not exceed the predetermined value (S3806: NO), the control unit 5 scans the laser beam 11 toward the target position at the predetermined speed in the X direction (S3807).

The control unit 5 then determines whether the scan of the laser beam 11 has reached the first or second end, which is the target position (S3808). If the laser beam 11 has reached the target position (S3808: YES), the control unit 5 proceeds to S3809. Alternatively if the laser beam 11 has not reached the target position of either of the ends (S3808: NO), the control unit 5 returns to S3806.

In S3809, the control unit 5 sets the target position in the Y direction for the sub scan of the laser beam 11. The target position in the Y direction set on this occasion is a position in the sub scan direction separated by the predetermined distance from the present position of the laser beam 11. The control unit 5 determines whether the laser beam 11 has exceeded a terminal end of the scan range in the sub scan direction (scan range in the Y direction set in S36) or not (S3810). If the control unit 5 determines that the laser beam 11 has exceeded the terminal end in the Y direction (S3810: YES), the control unit 5 proceeds to S3811. If the control unit 5 determines that the laser beam 11 has not exceeded the terminal end in the Y direction (S3810: NO), the control unit 5 returns to S3805.

In S3811, the control unit 5 determines whether the procedure which obtains the initial position information in the X and Y directions in S3801 has been repeated a predetermined number of times or more. If the procedure of obtaining the initial position information has been repeated a predetermined number of times or more (S3811: YES), the control unit 5 finishes the procedure in the flowchart in FIG. 8. In this case, the control unit 5 determines that the center search procedure has not been finished successfully, and shows an error on the display means, not shown, and suspends the operation of the CPE for the optical communication provided with the incident laser beam output section 200. If the procedure which obtains the initial position information has been repeated less than the predetermined number of times (S3811: NO), the control unit 5 returns to S3801, obtains new initial position information, and carries out the search procedure for the center of the core 33 in a search range different from the previous one.

After the search procedure for the center of the core 33 in S38 has been finished, the control unit 5 then determines whether lead-in has been completed or not (S39). The lead-in herein implies an operation which controls the servo system such that the center of the laser beam 11 coincides with the center of the core 33 once the laser beam 11 overlaps the core 33. If the control unit 5 determines that the lead-in, namely, the positioning (i.e., adjustment) between the center of the laser beam 11 and the center of the core 33, has been completed (S39: YES), the control unit 5 proceeds to S4 in FIG. 4. If the control unit 5 determines that the lead-in has not been completed (S39: NO), the control unit 5 returns to S37.

As shown in the flowchart in FIG. 5, if the search procedure of the core center is carried out on the two stages (S33 and S38 herein), the center search procedure without intending the lead-in may be carried out for a search in a wide range (center search procedure immediately after manufacturing using the preliminary initial position and scan range, for example). Consequently, the procedure can be carried out fast at least in the main scan direction. When the search procedure is subsequently carried out within a narrow area, the wobbling may be carried out from the beginning of the search, and then, the lead-in may be carried out as soon as the center search has been completed (center search procedure using the initial position stored on the memory 52, for example). Consequently, the time required for the center search procedure can be reduced.

A description will now be given of an example of numerical conditions for respective parameters required for carrying out the positioning control by means of the wobbling and the center search. For example, if the acceleration sensitivity in the X and Y directions of the actuator 7 is 10×10⁶ (m/s²), the amplitude of the laser beam 11 required for the wobbling is 1 (μm), and the lateral magnification of the optical system is 1, the amplitude of the objective lens 2 is 1/(1+1)=0.5 (μm). If a permissible wobbling current in one direction is 100 (mA), since 10×10⁶/(2×π×fw)²=5×10⁻⁴ (mm) where fw denotes the wobbling frequency, the maximum frequency is 2.25 (kHz). In the first embodiment, since the displacement can be detected twice in one cycle of the wobbling, the maximum sampling frequency is 4.5 (kHz). The cutoff frequency in a servo system for positioning is generally approximately 1/10 of the sampling frequency. The cutoff frequency is thus 450 (Hz) at the maximum in the first embodiment. The linearity of the detection of the displacement due to the wobbling is practically maintained if the center of the laser beam 11 is present within the extent of the core 33. Thus, if the diameter of the core 33 is 10 (μm) as described above, the range where the linearity of the detection of the displacement due to the wobbling is maintained is within 5 (μm) from the center of the core 33. If the cutoff frequency is 450 (Hz), an inrush speed Vin which the positioning system based on the wobbling according to the present embodiment can carry out the lead-in is approximately proportional to a product of the range where the linearity of the detection of the displacement is maintained and the cutoff frequency of the positioning system. The inrush speed herein implies an initial speed when the positioning control starts. Thus, the maximum permissible value of the inrush speed Vin is: Vin=0.005×2×π×450□14 (mm/s).

A description will now be given of the center search. If the scan is carried out as described in FIG. 9, since both the diameter of the laser beam 11 and that of the core 33 are 10 (μm), the gap between the laser beam 11 and the core 33 must be 10 (μm) or less during the sub scan. In consideration of the light intensity level used to detect that the laser beam 11 is incident on the core 33, and various variations on this occasion, the gap between the laser beam 11 and the core 33 is set to 5 (μm) or less. It is desirable to increase the gap between scan paths in the sub scan direction in order to reduce the time required for the center search, and thus, the gap is set to 10 (μm).

If an interference acceleration is exerted during the main scan in the X direction, there appear such influences as a change in the scan speed in the X direction, and a displacement in the Y direction. The influence on the scan speed causes a variation in the inrush speed which appears when the operation is switched to the displacement detection by means of the wobbling.

For example, if the interference acceleration of 2000 (m/s²) is exerted in the Y direction, and the center distance between the laser beam 11 and the core 33 is set to 7 (μm) or less in order to cause the light having sufficient quantity which is surely detectable by the photodetector 4 to enter the core 33, the displacement permissible in the positioning servo system is represented as: 7−5=2 (μm). The cutoff frequency fc required for the positioning servo system is 159 (Hz) or more, since 2000/(2×π×fc)²=2×10⁻³ (mm).

It is-assumed that the scan speed in the main scan direction is 7 (mm/s) which is the half of the maximum permissible inrush speed, and it is necessary to restrain a speed variation due to the influence of the interference acceleration to 2 (mm/s) or less. A residual speed displacement after exertion of an interference acceleration is inversely proportional to the cutoff frequency of a speed control system. Thus, the cutoff frequency fv of the speed control system in the main scan direction is 159 (Hz) or more, since the 2000/(2×π×fv)²=2×10⁻³ (mm).

### Second Embodiment

A description will now be given of a two-dimensional position control apparatus according to a second embodiment of the present invention.

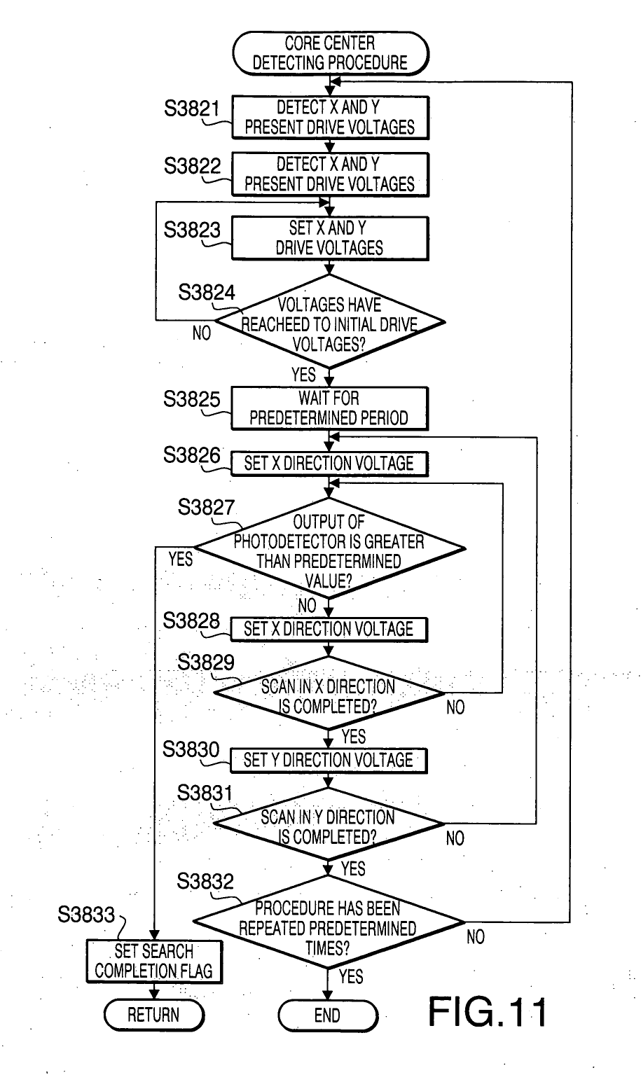

FIG. 10 schematically shows the configuration of an laser beam input module 200a according to the second embodiment. FIG. 11 shows a flowchart which corresponds to the flowchart in FIG. 8 according to the first embodiment, and illustrates search procedure for the core center according to the second embodiment. It should be noted that like components in the laser beam input module 200a according to the second embodiment are denoted by like numerals as of the laser beam input module 200 according to the first embodiment shown in FIGS. 1 to 9, and a detailed description will not be herein provided. A description will now be given of the configuration and an operation of the laser beam input module 200a with reference to FIGS. 10 and 11.

The laser beam input module 200a according to the second embodiment is not provided with the position sensor 73 which detects the position of the objective lens 2, which is different from the laser beam input module 200 according to the first embodiment. Therefore, the second embodiment is configured such that the structure is simplified and the cost is reduced compared with the first embodiment. In the second embodiment, the position information of the objective lens 2 is obtained by detecting DC components of output voltages of the actuator driving amplifier 6.

A description will now be given of the core center search procedure according to the second embodiment.

The flow chart in FIG. 11 corresponds to the flowchart in FIG. 8 (namely the step S38 in FIG. 5) as described above. Thus, the procedure of the flowchart in FIG. 11 starts immediately after the step S37 in FIG. 5 has been completed, and the step S39 in FIG. 5 starts immediately after the procedure of the flowchart in FIG. 11 has been completed.

A control unit 5a which manages control in the entire laser beam input module 200a firstly clears a flag indicating the completion of the search for the center of the core 33 in S3821. Then, the control unit 5 detects the DC components of the respective output voltages of the actuator driving amplifier 6, thereby obtaining the present position information of the objective lens 2. The control unit 5a can obtain the present position information of the objective lens 2 based on the DC components presently detected, the acceleration per current (acceleration sensitivity), the resonance frequency and the coil resistance of the actuator 7.

The control unit 5a then converts the initial position information in the X and Y directions in the memory 52 stored in S35 of FIG. 5 to the DC components of the respective output voltages of the actuator driving amplifier 6, and then, obtains the converted values as initial drive voltages (S3822).

If the control unit 5a obtains the initial drive voltages, the control unit 5a calculates respective change speeds of the drive voltages in the X and Y directions which are used to change the DC components (namely the position of the objective lens 2) of the output voltages of the actuator driving amplifier 6 to the initial drive voltages (namely the initial position) over a predetermined period. The control unit 5a then sets the drive voltages in the X and Y directions of the actuator driving amplifier 6 to smoothly reduces the respective differences between the drive voltages and-initial drive voltages over the predetermined period (S3823), thereby changing the drive voltages subsequently. If the detected DC components have reached the respective initial drive voltages (S3824: YES), the control unit 5a retains/stabilizes this state for a predetermined period (S3825) to carry out the search procedure for the center of the core 33. If the detected DC components have not reached the respective initial drive voltages (S3824: NO), the control unit 5a returns to S3823.

The control unit 5a carries out the procedure of searching for the center of the core 33 in S3826 and subsequent steps. The center search procedure according to the second embodiment is carried out similarly to that of the center search procedure according to the first embodiment.

In S3826, the control unit 5a sets a target drive voltage in the X direction for the main scan of the laser beam 11 from the first end to the second end as described above. The target drive voltage in the X direction set on this occasion is a drive voltage which can be output when the laser beam 11 exists at the second end if the present position of the laser beam 11 is the first end. The target drive voltage in the X direction is a drive voltage which can be output when the laser beam 11 exists at the first end if the present position of the laser beam 11 is the second end.

The control unit 5a carries out the main scan of the laser beam 11 from the first end to the second end (or from the second end to the first end) while changing the drive voltage, and determines whether the output of the photodetector 4 exceeds the predetermined value as in the first embodiment (S3827). If the output of the photodetector 4 exceeds the predetermined value (S3827: YES), the control unit 5a sets a flag which indicates that the center search is successful (S3833), and proceeds to S39 in FIG. 5. If the output of the photodetector 4 does not exceed the predetermined value (S3827: NO), the control unit 5a sets a target drive voltage in the X direction such that the drive voltage in the X direction changes at the set ratio so as to scan the laser beam 11 in the X direction at a constant speed (S3828).

The control unit 5a then detects the drive voltage to determine whether the drive voltage reaches the target drive voltage in the X direction (whether the laser beam 11 reaches the first or second end) (S3829). If the drive voltage has reached the target drive voltage in the X direction (S3829: YES), the control unit 5a proceeds to S3830. If the drive voltage has not reached the target drive voltage in the X direction (S3829: NO), the control unit 5 returns to S3827.

In S3830, the control unit 5a sets a target drive voltage in the Y direction for the sub scan of the laser beam 11. The target drive voltage in the Y direction set on this occasion is a drive voltage which can be output when the laser beam 11 exists at a position separated by a predetermined distance from the present position in the sub scan direction. The control unit 5a determines whether the position of the laser beam 11 reaches the terminal end of the scan range in the sub scan direction (scan range in the Y direction set in S36) or not (S3831). If the control unit 5a determines that the laser beam 11 reaches the terminal end in the Y direction (S3831: YES), the control unit 5a proceeds to S3832. If the control unit 5a determines that the laser beam 11 has not reached the terminal end in the Y direction (S3831: NO), the control unit 5a returns to S3827.

In S3832, the control unit 5a determines whether the procedure which obtains the initial drive voltages in the X and Y directions in S3822 has been repeated a predetermined number of times or more. If the procedure of obtaining the initial drive voltages has been repeated the predetermined times or more (S3832: YES), the control unit 5a finishes the procedure shown in FIG. 11. In this case, the control unit 5a determines that the center search procedure has not been finished successfully, and shows an error message on the display, not shown, and suspends the operation of the CPE for the optical communication provided with the incident laser beam output section 200a. If the procedure which obtains the initial drive voltages has been repeated less than the predetermined number of times (S3832: NO), the control unit 5a returns to S3821, obtains new initial position information, and carries out the search procedure for the center of the core 33 in a search range different from the previous one.

### Third Embodiment

A description will now be given of a two-dimensional position control apparatus according to a third embodiment of the present invention.

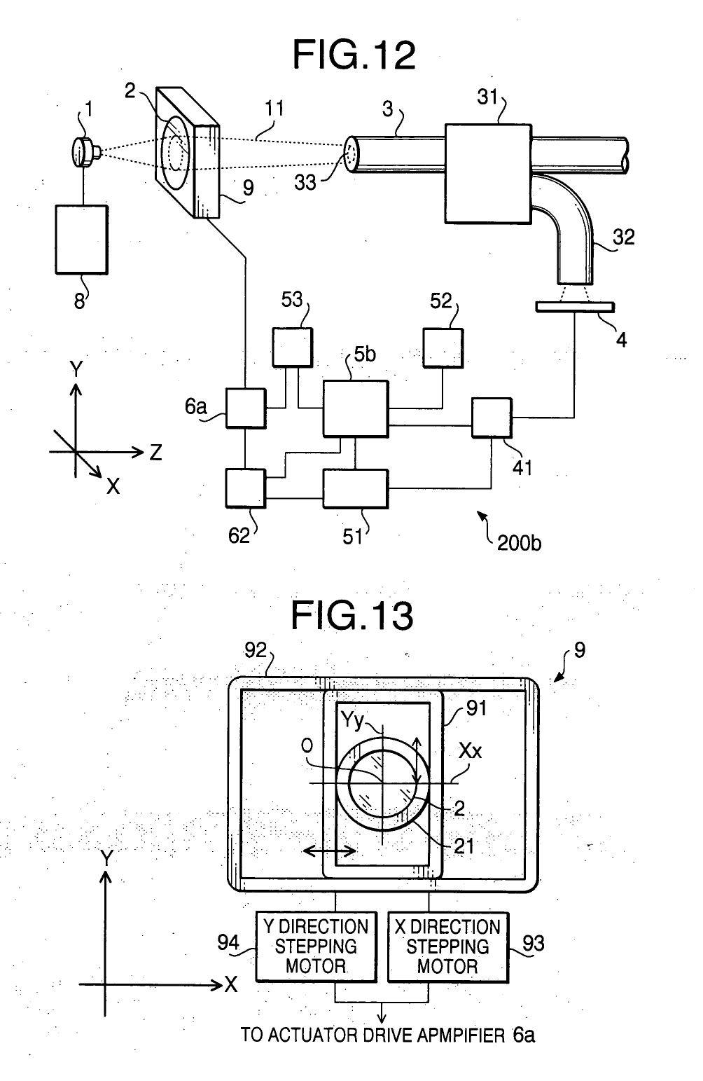

FIG. 12 schematically shows the configuration of a laser beam input module 200b according to the third embodiment of the present invention. It should be noted that like components in the laser beam input module 200b according to the third embodiment are denoted by like numerals as of the laser beam input module 200 according to the first embodiment shown in FIGS. 1 to 9, and a detailed description will not be herein provided.

The laser beam input module 200b is provided with an actuator unit 9 in place of the actuator 7, the support spring 71, the lens holder 72, and the position sensor 73, and the objective lens 2 is wobbled by an action of the actuator unit 9. An actuator driving amplifier 6a drives stepping motors 93 and 94 provided for the actuator unit 9.

FIG. 13 schematically shows the configuration of the actuator unit 9 serving as a component of the third embodiment of the present invention. A description will now be given of the configuration and an operation of the actuator unit 9 with reference to FIG. 13.

The actuator unit 9 includes a first frame body 91 which holds the objective lens 2 and a lens frame 21 holding the objective lens 2, a second frame body 92 which holds the first frame body 91, the stepping motor for the X direction 93 which moves the first frame body 91 in the X direction, and the stepping motor for the Y direction 94 which moves the lens frame 21 in the Y direction.

The first frame body 91, which is disposed within an opening of the second frame body 92, is held so as to move along inner walls of the second frame body 92 which extends in parallel with the X direction. If the actuator driving amplifier 6a supplies the X direction stepping motor 93 with pulses, the X direction stepping motor 93 rotates according to the number of the supplied pulses, and consequently the first frame body 91 moves in the X direction within the second frame body 92. On this occasion, the control unit 5b counts the number of the pulses output from the actuator driving amplifier 6a to determine the position of the first frame body 91 (namely the objective lens 2) in the X direction.

The lens frame 21 is disposed within an opening of the first frame body 91, and is held so as to move along inner walls of the first frame body 91 which extends in parallel with the Y direction. If the actuator driving amplifier 6a supplies the Y direction stepping motor 94 with pulses, the Y direction stepping motor 94 rotates according to the number of the supplied pulses, and consequently the lens frame 21 moves in the Y direction within the first frame body 91. On this occasion, the control unit 5b counts the number of the pulses output from the actuator driving amplifier 6a to determine the position of the lens frame 21 (namely the objective lens 2) in the Y direction.

In the third embodiment, the X direction stepping motor 93 and the Y direction stepping motor 94 are driven at the same time, and the movements of the stepping motors 93 and 94 are combined to oscillate the objective lens 2 along an elliptic locus. Consequently, the laser beam 11 is wobbled along the elliptic locus on the end surface of the optical fiber 3. Since the objective lens 2 is wobbled by means of the stepping motors in the third embodiment, the wobbling does not behave as a second order delay system. Therefore, the wobbling control can be simplified.

A line halving the first frame body 91 in the Y direction is set as an axis Xx, a line halving the second frame body 92 in the X direction is set as an axis Yy, and an intersection of these axes (namely the center point of the actuator unit 9 in FIG. 13) is set as a center point O. In addition, the center point O and the optical axis of the objective lens 2 coincide with each other at the initial position of the objective lens 2 within the actuator unit 9, and the objective lens 2 elliptically oscillates about the center point O. If the wobbling detection timing for the detection of the displacement in the X direction is set to two points where the objective lens 2 is on the axis Xx, the control unit 5b can detect the displacement of the objective lens 2 simply by counting the number of the pulses supplied to the X direction stepping motor 93. Similarly, if wobbling detection timing for the detection of the displacement in the Y direction is set to two points where the objective lens 2 is on the axis Yy, the control unit 5b can detect the displacement of the objective lens 2 simply by counting the number of the pulses supplied to the Y direction stepping motor 94. The third embodiment can also simplify the wobbling control in these respects. Consequently, the third embodiment can reduce time consumed for numerical operation and the like, thereby carrying out the position control at a high speed.

### Fourth Embodiment

A description will now be given of a two-dimensional position control apparatus according to a fourth embodiment of the present invention.

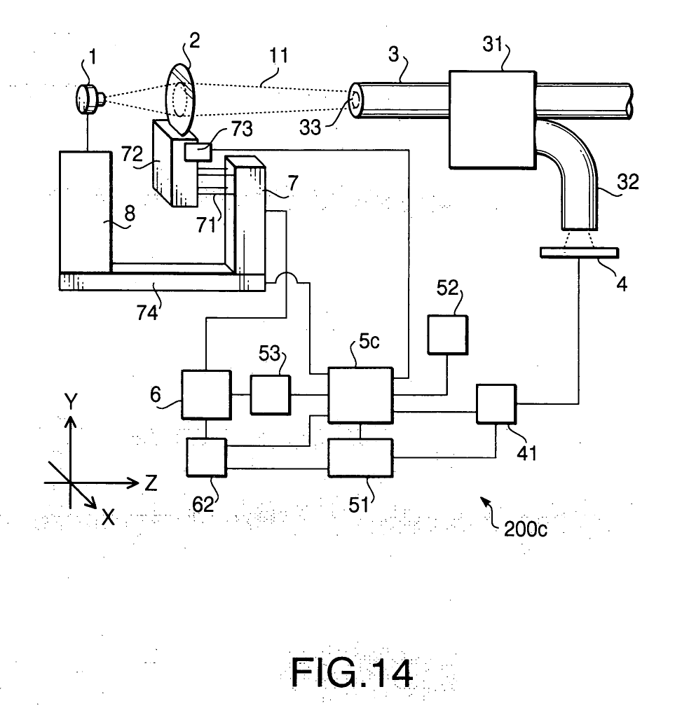

FIG. 14 schematically shows the configuration of a laser beam input module 200c according to the fourth embodiment of the present invention. It should be noted that like components in the laser beam input module 200c according to the fourth embodiment are denoted by like numerals as of the laser beam input module 200 according to the first embodiment shown in FIGS. 1 to 9, and a detailed description will not be herein provided.

The laser beam input module 200c according to the fourth embodiment is provided with scan system 74 which mounts the laser diode 1, the laser diode drive device 8, and the actuator 7, and moves the mounted components in the X and Y directions. The scan system 74 is constructed using guide mechanisms extending in the X and Y directions, and stepping motors moving the guide mechanisms, for example. The scan system 74 can move the mounted actuator 7 and laser diode 1 in the X and Y directions by causing the stepping motors to rotate feed screws included in the guide mechanisms. Employing the scan means 74 allows moving the laser diode 1 in the X and Y directions in a wide range according to the number of pulses supplied by the control unit 5c. Thus, even if the position of the fiber 3 varies largely, or an incident laser beam output section provided with a plurality of optical fibers is employed, it is possible to fall the laser beam 11 upon the optical fiber 3 disposed at a desired position. In addition, the drive mechanisms other than the actuator 7 can be employed, and it is thus possible to set better speeds and range of the scan.

According to the two-dimensional position control method and the two-dimensional position control apparatus described above, the signal which contains information and the signal input system to which the signal is input are oscillated such that the locus of the relative movement thereof forms an ellipse on the predetermined two-dimensional plane. Hence, it is possible to detect the displacements both in the X and Y directions at the same time by system of the wobbling in one cycle, and consequently, the displacements can be detected promptly. Employment of the two-dimensional position control method, and the two-dimensional position control apparatus according to the present invention eliminates the conventional position control carried out sequentially in the X and Y directions.

Additionally, since the position control can be carried out both in the X and Y directions using the same frequency, the minimum frequency can be used for the position control in the both directions. Consequently, the heat generation and the power consumption of the apparatus can be efficiently restrained. Additionally, since the scanning system is employed for scanning the laser beam, the position control can be efficiently carried out by system of scan of the laser beam at two levels of scan speed different from each other, for example.

The present invention has been described in conjunction with the preferred embodiments. The present invention is not limited to the embodiments described above, and various variations may be possible without departing from the scope of the invention.

The present disclosure relates to the subject matter contained in Japanese Patent Application No. 2003-366912, filed on Oct. 28, 2003, which is expressly incorporated herein by reference in its entirety.

1. A two-dimensional position control method, comprising:
oscillating at least one of a space propagation energy distributed in a substantially limited range on a predetermined two-dimensional plane and an energy input system to which the space propagation energy is input, such that a locus formed by a relative movement of the space propagation energy and the energy input system on the two-dimensional plane is an ellipse;
detecting energies at at least two pairs of points on the elliptic locus, each pair of points being disposed on opposite sides with respect to the center of the ellipse;
calculating differences between the detected energies at the respective pairs of points; and
detecting a displacement between the energy and the energy input system on the two-dimensional plane in accordance with the differences between the detected energies.

2. The two-dimensional position control method according to claim 1, wherein the oscillating, the energy detecting, calculating and displacement detecting are repeated until the respective differences between the detected energies reach a predetermined value.

3. The two-dimensional position control method according to claim 1, wherein the pair of points are disposed at positions symmetrical about the center of the ellipse.

4. The two-dimensional position control method according to claim 3, wherein the displacement is detected in a direction parallel to a line connecting the pair of points.

5. The two-dimensional position control method according to claim 1,
further comprising scanning one of the energy and the energy input system within a predetermined area on the two-dimensional plane,
wherein, if a difference between the energies within a predetermined range is detected in the scanning, information on positions corresponding to the difference between the energies is obtained.

6. A two-dimensional position control apparatus, comprising:
an energy output system that outputs a space propagation energy distributed in a substantially limited range on a predetermined two-dimensional plane;
an energy input system to which the energy is input;
an oscillating system that oscillates at least one of the energy and the energy input system such that a locus formed by a relative movement of the space propagation energy and the energy input system on the two-dimensional plane is an ellipse;
an energy detecting system that detects energies at at least two pairs of points on the elliptic locus on both sides of the center of the ellipse; and
a displacement detecting system that calculates differences between the detected energies at the respective pairs of points, thereby detecting a displacement between the energy and energy input system on the two-dimensional plane.

7. The two-dimensional position control apparatus according to claim 6, further comprising a control system that carries out negative feedback control such that the difference between energies detected by displacement detecting system reaches a predetermined value.

8. The two-dimensional position control apparatus according to claim 6, wherein the energy detecting system detects points symmetrical about the center of the ellipse as the pair of points.

9. The two-dimensional position control apparatus according to claim 6, wherein oscillating system moves one of the energy output system and the energy input system in a first direction and in a second direction which is orthogonal to the first direction on the two-dimensional plane such that a locus of the combined movements in the two directions forms the ellipse.

10. The two-dimensional position control apparatus according to claim 6, wherein displacement detecting system detects the displacement in a direction parallel to a line connecting the pair of points with each other.

11. The two-dimensional position control apparatus according to claim 10, wherein system energy detecting system detects the respective points such that at least two lines connecting the pairs of points with each other are parallel to at least one of the first direction and the second direction which is orthogonal to the first direction, on the two-dimensional plane.

12. The two-dimensional position control apparatus according to claim 6,
wherein the energy is a light flux presenting a Gaussian distribution; and
wherein the at least two pairs of points are obtained to detect a center position of the light flux.

13. The two-dimensional position control apparatus according to claim 12, wherein energy input system is an optical fiber having a core diameter approximately equal to the diameter of the light flux.

14. The two-dimensional position control apparatus according to claim 12, wherein the two-dimensional plane is an incident end surface of the optical fiber upon which the light flux falls.

15. The two-dimensional position control apparatus according to claim 6, further comprising:
a scanning system that scans either the energy or energy input system within a predetermined area on the two-dimensional plane; and
a position information obtaining system that obtains information on positions corresponding to a difference between energies if the difference between the energies is within a predetermined range based on the energies detected by the scanning system during the scan of the energy or energy input system.
